(19) United States
(12) Patent Application Publication
(10) Pub. No.: US 2022/0232363 A1
(43) Pub. Date: Jul. 21, 2022

(54) TELECOMMUNICATION NETWORK FOLLOWING A DISASTER CONDITION

(71) Applicant: Samsung Electronics Co., Ltd., Gyeonggi-do (KR)

(72) Inventors: Mahmoud WATFA, Middlesex (GB); Lalith KUMAR, Bengaluru (IN)

(21) Appl. No.: 17/576,331

(22) Filed: Jan. 14, 2022

(30) Foreign Application Priority Data
Jan. 16, 2021 (IN) 202131002087
Nov. 3, 2021 (IN) 202131050554
Jan. 13, 2022 (GB) 2200411.3

(51) Int. Cl. H04W 4/90; H04W 60/04; H04W 4/12

(52) U.S. Cl. CPC H04W 4/90; H04W 84/042; H04W 4/12; H04W 60/04

(57) ABSTRACT

A method and an apparatus are provided for controlling access to a network supporting disaster roaming. The network receives a non-access stratum (NAS) message from a user equipment (UE). The network verifies at least one condition in response to the NAS message. Based on the at least one condition, the network accepts the NAS message and indicates that the UE is registered for emergency services.

### CROSS-REFERENCE TO RELATED APPLICATION(S)

This application is based on and claims priority under 35 U.S.C. § 119(a) to Indian Provisional Patent Application No. 202131002087, filed in the Indian Intellectual Property Office on Jan. 16, 2021, Indian Provisional Patent Application No. 202131050554, filed in the Indian Intellectual Property Office on Nov. 3, 2021, and UK Patent Application No. GB 2200411.3, filed in the UK Intellectual Property Office on Jan. 13, 2022, which are incorporated herein by reference in their entireties.

### BACKGROUND

### 1. Field

The present disclosure relates to telecommunication network improvements following a disaster condition (DC), and more particularly, to the efficient provision of services to disaster inbound roamers in the event of a DC arising in a telecommunication network.

### 2. Description of Related Art

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

In general, the purpose of a Mobile Information and Network Technologies (MINT) is to minimize interruption of service to users of a User Equipment (UE) when a wireless network to which these users are subscribed cannot provide service due to a disaster such as, for example, a fire, by enabling the users to obtain service on other networks, while at the same time protecting those other networks from congestion.

A DC occurs when some or all of a network is unable to offer services to subscribers as a result of a disaster, such as, for example, a fire or an earthquake. In such circumstances, subscribers of an affected network may be allowed to roam and temporarily access another network that is not as affected.

Standards specification TS 22.261 lists some requirements to avoid service interruptions that may arise when a DC occurs on a given public land mobile network (PLMN) and for which user equipments (UEs) are to be redirected to another PLMN in a manner that keeps the service interruption to a minimum.

Referring to the Standards specification TS 22.261, a mobile network may fail to provide service in the event of a disaster (for example a fire.) UEs may obtain service in the event of a disaster, if there are PLMN operators prepared to offer service. The minimization of service interruption is constrained to a particular time and place. The potential congestion resulting from an influx or outflux of Disaster Inbound Roamers is taken into account.

When the DC occurs, 3GPP system (e.g., 5G system) may be able to enable a UE of a given PLMN to obtain connectivity service (e.g. voice call, mobile data service) from another PLMN for the area where a Disaster Condition applies. Further, the 3GPP system (e.g., 5G system) may enable UEs to obtain information that a Disaster Condition applies to a particular PLMN or PLMNs. If a UE has no coverage of its HPLMN, then obtains information that a Disaster Condition applies to the UE's HPLMN, the UE can register with a PLMN offering Disaster Roaming service. Further, the 3GPP system (e.g., 5G system) may support means for a PLMN operator to be aware of the area where Disaster Condition applies. The 3GPP system (e.g., 5G system) may be able to support provision of service to Disaster Inbound Roamer only within the specific region where Disaster Condition applies. Further, the 3GPP system (e.g., 5G system) may be able to provide efficient means for a network to inform Disaster Inbound roamers that a Disaster Condition is no longer applicable.

The 3GPP system may be able to provide means to enable a UE to access PLMNs in a forbidden PLMN list if a Disaster condition applies and no other PLMN is available except for PLMNs in the forbidden PLMN list. The 3GPP system may provide means to enable that a Disaster Condition applies to UEs of a specific PLMN. The 3GPP system may be able to provide a resource efficient means for a PLMN to indicate to potential Disaster Inbound Roamers whether they can access the PLMN or not. Disaster Inbound Roamers may perform network reselection when a Disaster Condition has ended.

The service interruption is limited to a particular time and place, and thus, only the UEs that are in the given location at the given time of disaster will be impacted by the DC and should be serviced by another PLMN.

### SUMMARY

According to an aspect of the disclosure, a method is provided for controlling access to a network supporting disaster roaming. The network receives a non-access stratum (NAS) message from a UE. The network verifies at least one condition in response to the NAS message. Based on the at least one condition, the network accepts the NAS message and indicates that the UE is registered for emergency services.

According to an aspect of the disclosure, an apparatus is provided that includes at least one processor and a memory operably connected to the at least one processor. The memory stores instructions configured to cause, when executed, the at least one processor to receive a NAS message from a UE, verify at least one condition in response the NAS message, and based on the at least one condition, accept the NAS message and indicate that the UE is registered for emergency services.

According to an aspect of the disclosure, a method performed by a UE to access a network supporting disaster roaming is provided. A NAS message is transmitted to the network. An indication that the UE is registered for emergency services is obtained from the network, based on a verification of at least one condition in response to the NAS message.

According to an aspect of the disclosure, a UE is provided that includes at least one processor and a memory operably connected to the at least one processor. The memory stores instructions configured to cause, when executed, the at least one processor to transmit a NAS message to the network, and obtain, from the network an indication that the UE is registered for emergency services, based on a verification of at least one condition in response to the NAS message.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating RAN and non-3GPP access points connected to an AMF within a PLMN;

FIG. 2 is a diagram illustrating a DC area covering a rectangular geographic area;

FIG. 3 is a diagram illustrating a DC area that overlaps with a coverage area of another PLMN not affected by the DC, according to an embodiment; and

FIG. 4 is a diagram illustrating a message flow, according to an embodiment.

### DETAILED DESCRIPTION

Embodiments are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the disclosure. The embodiments and the terms used therein are not intended to limit the technology disclosed herein to specific forms, and should be understood to include various modifications, equivalents, and/or alternatives to the corresponding embodiments. A singular expression may include a plural expression unless they are definitely different in a context

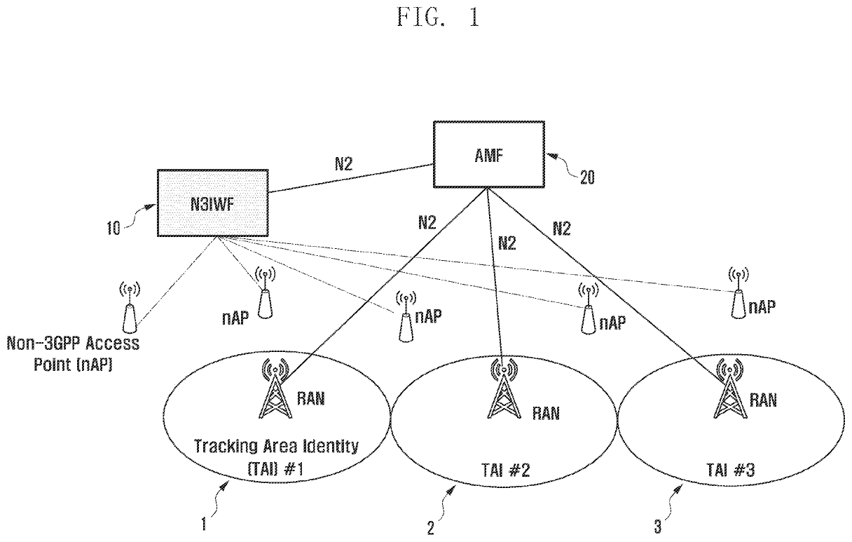

It is assumed that a DC can occur on a radio access network level for which radio towers will be non-functional, and thus, the UE cannot connect to the PLMN in the area where the DC occurred. FIG. 1 is a diagram illustrating RANs and non-3GPP access points connected to an access & mobility management function (AMF) within a PLMN. AMF 20 is connected to RAN 1, RAN 2, RAN 3, and a non-3GPP interworking function (N3IWF) 10. The N3IWF 10 is connected to a number of non-3GPP access points (nAPs).

Normally, every cell (or RAN node, which may support multiple cells) broadcasts a tracking area identity (TAI), or a tracking area code (TAC) in addition to a PLMN identity, which form the TAI of the cell. The UE identifies the PLMN ID (or TAI) of a cell based on this broadcasted information.

Note that PLMN ID=mobile country code (MCC)+mobile network code (MNC); and TAI=PLMN ID+tracking area code (TAC)=MCC+MNC+TAC.

A UE that registers to the fifth generation system (5GS) is provided with a registration area (RA) that consists of a set of one or more TAIs in which the UE is allowed to enter without performing a registration procedure, except for periodic updating or other reasons. For example, if the UE registers and receives an RA that is composed of TAI #1 and TAI #2, then the UE can move from TAI #1 to TAI #2 in an idle mode without sending a registration request. However, if the UE enters a new area that is not part of the UE's RA (e.g., TAI #3), then the UE is required to perform a registration procedure in order to get services during which the network will provide a new RA, assuming the UE is allowed to use the service in TAI #3.

When a DC occurs, the RAN nodes may be down and, as such, the UE may not receive any broadcast information and may not be able to receive any system information that would otherwise enable the UE to determine the PLMN ID or the TAI of the cell. The UE would not detect a cell when this occurs.

This assumes that the DC impacts the RAN such that no information can be sent by the RAN and, as such, the UE cannot detect the presence of the cell as per normal methods.

As described above, a DC may be limited to a certain place and time. It is possible that the DC impacts one or more TAIs. For example, the DC may impact the area covered by TAI #1 only, TAI #2 only, TAI #3 only, TAI #1 and TAI #2 only, TAI #2 and TAI #3 only, or TAI #1 and TAI #2 and TAI #3.

Additionally, a TAI, or a set of TAIs, may also correspond to a particular geographic area (e.g., a set of geographical coordinates). This set may define a particular shape such as a triangle, rectangle, or any other polygon.

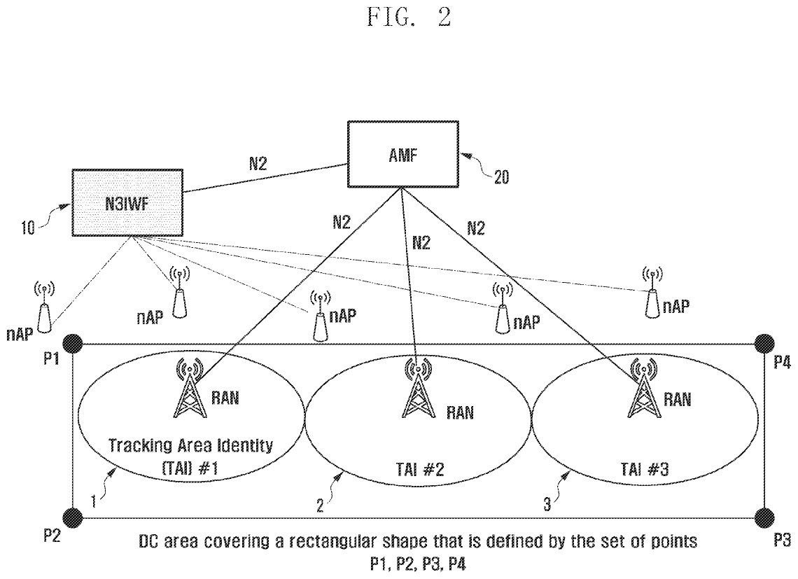

For example, the DC may span all the TAIs 1, 2, 3 shown in FIG. 2 such that the DC is composed of a set of 4 coordinate points (P1, P2, P3, P4) that define a rectangular shape that covers the cells that broadcast TAI #1, TAI #2, and TAI #3.

When a DC occurs, and the UE is aware of the DC, the UE will attempt to register on another PLMN. This other PLMN may be a visited PLMN (VPLMN) (i.e., not the UE's home PLMN (HPLMN)). The UE may be allowed to use a PLMN in a list of forbidden PLMNs maintained by the UE.

When the UE registers on another PLMN where there is no DC, the UE can receive services from that PLMN (e.g. a target VPLMN), until the DC in its source PLMN (e.g., HPLMN or a previous source VPLMN) ends. The UE can then return to the previous PLMN.

As UEs go to a target PLMN due to a DC, or return to source PLMN after a DC ends, congestion on a (target or source) PLMN resulting from a large number of UEs attempting registration at the same time should be avoided.

There is a requirement that a 3GPP system be able to support provision of service to a disaster inbound roamer only within the specific region where the DC applies.

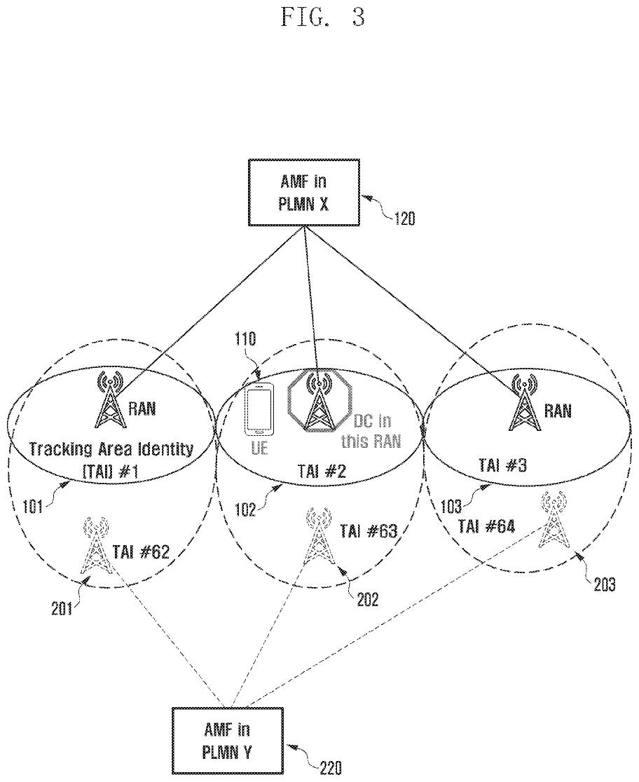

FIG. 3 is a diagram illustrating a DC area that overlaps with a coverage area of another PLMN not affected by the DC, according to an embodiment. FIG. 3 shows AMF 120 of PLMN X and AMF 220 of PLMN Y. Cells and TAIs belong to a given PLMN (PLMN X). PLMN X includes TAI #1 101, TAI #2 102, and TAI #3 103. PLMN Y includes TAI #62 201, TAI #63 202, and TAI #64 203.

Assuming that PLMN X experiences a DC that impacts a RAN node that broadcasts the TAI #2 102, a UE 110 may attempt to register onto PLMN Y. The coverage of PLMN Y overlaps with that of PLMN X. However, PLMN Y needs to ensure that the UE 110 will only use services from PLMN Y within the area of the DC in PLMN X. For example, since the DC affects the TAI #2 102 of PLMN X, then the UE 110 should only be allowed to use services in the overlapping area which is the TAI #63 202 of PLMN Y.

Another requirement is that disaster inbound roamers perform network reselection when a DC has ended. This relates to reselection when a DC ends. However, it is possible that the UE returns to its PLMN when it leaves the area of the DC.

A further requirement is that the 3GPP system minimize congestion caused by disaster roaming.

For example, many UEs try to access the 5G core (5GC) of the target PLMN, which is not experiencing a DC. This may overload the 5GC of the target PLMN.

Several UEs may register to the same target PLMN. After registration, each of these UEs may request the establishment of protocol data unit (PDU) sessions towards the same slice and/or data network name (DNN), which may overload the same session management function (SMF) nodes. Furthermore, the AMF will be overloaded since each 5G session management (5GSM) message is transported to the SMF via the AMF. Therefore, both the AMF and SMF nodes may be overloaded due to the sudden surge in 5GSM requests. This may well overload the system and impact both existing and new UEs that use the target PLMN (i.e., the PLMN without the DC).

Service area restrictions may be used to constrain the services of a UE within the area of the DC.

A DC may occur in PLMN X and the DC may span a certain area. The UE 110 may select and attempt to register on another PLMN (e.g., PLMN Y). However, it is required that PLMN Y only provide service to the UE 110 in an area where the DC is known to occur.

To meet this requirement, it may be assumed that the target PLMN (PLMN Y without the DC) knows the area of the disaster condition. This may be achieved by operators of both PLMNs exchanging information with each other and identifying the area of the DC.

In order for this solution to work, the target PLMN (i.e., any node or network function (NF) of the target PLMN Y) should use the received information about the area of the DC and map it to a coverage area in the target PLMN.

For example, the DC in another PLMN is mapped to any combination of the following: a geographical area that is composed of a set of coordinates; a RA having a list of TAIs, and which may be larger than the area of the DC; and a set of TAIs, which may or may not be within one specific RA, such that the set of TAIs would map, as closely as possible, to the area of the DC.

When a UE, due to a DC in a previous PLMN (e.g., PLMN X), registers on another PLMN (e.g., PLMN Y) that does not have the DC, in order to receive normal service, the UE may indicate that it is registering to PLMN Y due to the DC. This indication may be provided by introducing a new indication or a new bit in a new information element (IE) or an existing IE. For example, the existing 5GS update type IE can be used for this purpose, where one of the existing bits can be defined to indicate “registration due to a disaster condition”, “registration due to temporary service unavailability in source PLMN”, or similar.

Similarly, for such a UE, based on the new indication described above, the AMF 220 in the new PLMN should indicate to the UE 110 that the registration for a DC has been accepted. The AMF 220 may do so by using a new bit in a new IE or an existing IE. For example, a new bit in the 5GS registration result IE (or 5GS network feature support IE) can be used to inform the UE 110 that the current registration is accepted as a result of a DC in the UE's source PLMN. For example, the bit may be used to indicate “registration due to a disaster condition”.

The IE may be a newly-defined IE or an existing IE. The values used for the bit positions are examples and can be defined to indicate something different, but still with the common objective to indicate that a registration is being performed due to a DC, and the registration is accepted following a DC, respectively by a UE and the network (e.g., AMF).

The UE may determine that its registration is accepted due to a DC based on either receiving a new value, new bit, or new indication in a registration accept message, as described above (e.g., a new bit in the 5GS registration result IE). If the UE indicates that it is registering due to a DC in another PLMN and the UE's registration is accepted, then the UE can determine that it is registered in the current PLMN as a result of a DC in its source PLMN. The UE may locally store this information.

When the UE registers to a target PLMN following a DC in a source PLMN, the following features are provided to ensure that the UE's service is restricted, such that it is only serviced within the area of the DC.

The AMF may provide an RA to the UE (i.e., the list of TAIs), such that the TAIs are restricted to cover the area of DC that the AMF has determined as described above.

The AMF may provide the service area list IE, such that the AMF sets the TAIs as follows.
The AMF ensures that the service area would allow the UE to access normal service in an area that overlaps with the area of DC that was determined.
The AMF provides a service area list, which is an allowed service area that comprises a set of TAIs, such that the set of TAIs that are provided would map and be restricted to, as much as possible, the area of the DC that has been determined.
The AMF provides a service area list, which is a non-allowed service area where the provided TAI list are those TAIs that are not allowed, such that they exclude the area of the DC that has been determined.

In all of the above-described options, the objective is that the service area list that is provided to the UE should be such that the UE will only be allowed to obtain services in an area (e.g., a set of TAIs) that is restricted (as much as possible) to the area of DC that has been determined.

The AMF may also send a set of global cell IDs to offer finer control of the areas to which the service should be confined. The global cell IDs may be sent such that they may correspond to the TAIs of the service area list IE. The list of global cell IDs may be sent as a new IE or as part of an existing IE. As such, the AMF determines the DC area, determines the cells that are within this area, and sends the global cell ID of each cell that has been determined to overlap or be within the area of the DC.

The information sent to the UE (e.g., a list of TAIs, service area list with specific TAIs, or a new set of global cell IDs) may be used in any combination and sent to the UE in any combination.

The serving PLMN may use any NAS message to update the UE with any of the above information if a change has occurred (e.g., if the network (serving AMF) determines that the DC area has changed based on any new development with the DC).

When the UE receives a set of global cell IDs, the UE may store this list in a new list of “allowed cell list for DC” (where the name of the list may be different), and use these cell IDs to determine if it is within the DC area as follows.

The UE verifies if the global cell ID of the cell onto which it is camped is present within the list of global cell IDs that the UE has received and may have optionally stored. If the global cell ID is present, the UE can access the cell to get service. If the global cell ID is not present, the UE may, even if the TAI of the cell is in the UE's registration area, determine that service cannot be received via this cell. The UE may remain in the registered state, or may enter a new substrate to indicate that service cannot be received. The UE may respond to paging or notification message or may perform a registration procedure, but optionally without including the uplink data status IE.

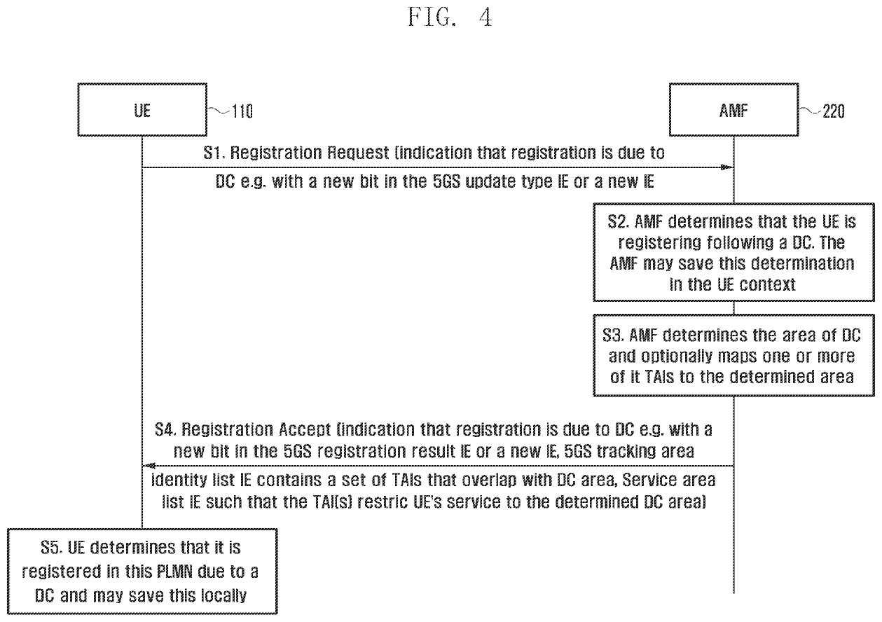

FIG. 4 is a diagram illustrating a message flow, according to an embodiment. Specifically, FIG. 4 shows messages exchanged between the UE 110 and the AMF 220 of PLMN Y.

At S1, the UE 110 sends a registration request to the AMF 220. At S2, the AMF 220 determines that the UE is registering following a DC. The AMF 220 may save this determination in the UE context. At S3, the AMF 220 determines the area of the DC and optionally maps one or more of its TAIs to the determined area. At S4, the AMF 220 sends a registration accept to the UE 110. At S5, the UE 110 determines that it is registered in this PLMN due to a DC and may save this locally.

The described steps can be used in any combination and the IEs that are listed should be considered as examples, whereas other existing IEs or new IEs can be used by the UE or the network, as required.

It is possible that the UE, while registered on a target PLMN that does not have a DC (e.g., PLMN Y) may move or enter a new cell that broadcasts a new TAI that is currently not in the UE's 5GS tracking area list IE. Specifically, the UE enters a new TAI that is currently not in the UE's registration area. When this occurs, the UE sends a registration request message to register with the network.

When the network receives a registration request from the UE, the network (e.g., the AMF 220) determines the UE's location. For example, the UE's location may be determined based on the global cell identifier of the RAN node, which is known to the AMF from the message on the N2 interface between the RAN and the AMF. The network may then verify if the UE 110 is within the DC area or not. If the UE 110 is not within the DC area, the AMF 220 should reject the UE's registration and send a registration reject message. The AMF 220 may use a new 5G mobility management (5GMM) cause code “Roaming outside areas of network disaster not allowed”, or any of the existing 5GMM cause codes such as #12 “Tracking area not allowed”, #13 “Roaming not allowed in this tracking area”, or #15 “No suitable cells in tracking area”.

However, it is possible that the UE establishes (or already has) a PDU session for emergency services while it is registered for disaster roaming. The UE may then move into a new tracking area (TA) identified by a new TAI that is not part of the UE's current RA. In this case, the UE normally performs a registration procedure. Specifically, the UE sends a registration request message, as it has entered a new TAI. Two options for UE behavior and AMF behavior are described below.

In the first option, the UE behaves as follows. In the case that the UE is registered for disaster roaming, if the UE moves into a new TA that is not part of the UE's current RA, then if, additionally, the UE has a PDU session for emergency services that is already established, the UE should send the registration request message and may set the 5GS registration type IE to “emergency registration”. If the UE does not have a PDU session for emergency services, then the UE should set the 5GS registration type IE to “disaster roaming registration” or may set the 5GS registration type IE to “mobility registration updating”. A UE that has already registered for disaster roaming should preferably always set the 5GS registration type IE to “disaster roaming registration” except when the procedure is being performed for periodic update and except for the case that is described above (i.e., the UE moves into a new TA that is not part of the UE's current RA and the UE has a PDU session for emergency services). Similarly, the AMF should always indicate (implicitly or otherwise) that the UE is registered for disaster roaming, unless this is not the case, and as such the AMF should then indicate otherwise.

The UE may also locally release all other PDU sessions that are not related to the emergency service or that are non-emergency PDU sessions. The UE should consequently include the PDU session status IE in the registration request to indicate the PDU sessions that have become inactive in the UE and/or the PDU session that remains active in the UE, where the latter should be associated with the PDU session for emergency service. This IE should be set as above. Specifically, all non-emergency PDU sessions should be indicated as inactive except the PDU session for emergency service.

The UE may perform any combination of the actions described above.

The following describes AMF behavior. When the AMF receives a registration request from a UE that is registered for disaster roaming and the 5GS registration type indicates “emergency registration”, then if a registration request message is received (from a UE) and the TA of cell/NG-RAN node, from which the NAS message is received, is not part of the UE's current RA and the UE is currently registered for disaster roaming service, and if the UE does not have a PDU session for emergency services, then the AMF should reject the UE's NAS message. Specifically, the AMF should send a registration reject and include an appropriate new or existing 5GMM cause value (e.g. #11, #13, #15, etc, as described above).

If a registration request message is received (from a UE) and the TA of the cell/NG-RAN node (from which the NAS message is received) is not part of the UE's current RA and the UE is currently registered for disaster roaming service, and if the UE has a PDU session for emergency services (i.e., a PDU session for emergency service is established for the UE), then the AMF should take any combination of the following actions.

The AMF may verify if the TA of the cell/NG-RAN node (from which the NAS message is received) corresponds to an area that overlaps with the area of the DC (where this area of the DC is the area impacted by the DC for another PLMN, where the AMF may know this, based on local information in the AMF). If the TA of the cell/NG-RAN node (from which the NAS message is received) does overlap, then the AMF continues to consider the UE as registered for disaster roaming service. However, if the TA of the cell/NG-RAN node (from which the NAS message is received) does not overlap with the area of the disaster condition, then the AMF behaves as described in the following. Note that the order of the conditions verified does not matter and may be performed in any order. For example, the AMF may first verify whether the UE's current location (or TA of the cell/NG-RAN node from which the NAS message is received) overlaps with the area of DC. If not, then the AMF may subsequently verify if the UE has a PDU session for emergency services. If not, then the AMF rejects the NAS message, otherwise (i.e., if the UE has a PDU session for emergency) the AMF does not reject the NAS message but accepts it and considers the UE to be registered for emergency services as described below.

The AMF should accept the UE's request and send a registration accept message.

The AMF may indicate that the UE is registered for emergency services by setting the “Emergency registered” bit to 1 (i.e., to indicate registered for emergency services) in the 5GS registration result IE (of the registration accept message).

The AMF may send the configuration update command (CUC) message and include the 5GS registration result IE and indicate that the UE is registered for emergency services, where the CUC message can be sent during the registration procedure or after the registration procedure.

The AMF may request each SMF to release any PDU session that is not related to the emergency PDU session, that is not the PDU session for emergency services, or that is a non-emergency PDU session. The AMF may also perform a local release of such PDU sessions.

The AMF may include the PDU session status IE in the registration accept message to indicate which PDU session is now inactive (i.e. the non-emergency PDU sessions) and/or to indicate which PDU session is active (i.e. the emergency PDU session). This IE should be set as described above, where all non-emergency PDU sessions should be indicated as inactive except the PDU session for emergency service.

In summary, the AMF may need to verify at least one condition to consider the UE as registered for emergency services (and/or to indicate to the UE that it is registered for emergency services). The AMF verifies these conditions in any order:
Condition 1: the UE sends a NAS message from an area (e.g., cell/TA) that does not overlap with the area of the disaster condition;
Condition 2: the UE has an ongoing PDU session for emergency services; and
Condition 3: the UE is currently registered for disaster roaming service.

For any number of conditions, when the conditions are met (i.e., one or more from the above conditions), then the AMF determines/considers the UE to be registered for emergency services. The AMF may verify the conditions listed above in any order, and other conditions may also be defined.

The steps described herein apply for any NAS message and not just a registration request message, and so other NAS messages, such as service request messages, would be treated in a similar manner.

In the second option, the UE behavior is the same as that described for the first option with the exception that the UE need not set the 5GS registration type IE to “emergency registration”. The UE may set the IE to “disaster roaming registration” or may set the 5GS registration type IE to “mobility registration updating”. With this exception, all of the above-described behavior of the UE in the first option also applies for this second option.

For this second option, the AMF behaves in the same manner as that described above for the first option, even if the 5GS registration type does not indicate “emergency registration” (e.g., the 5GS registration type may indicate “disaster roaming registration” or “mobility registration updating”). As such, all of the above-described behavior of the AMF in the first option also apply for this option.

When a UE attempts to use a target PLMN due to a DC on a source PLMN, the UE may have saved any of the following lists corresponding to a PLMN:
“5GS forbidden tracking areas for roaming”
“5GS forbidden tracking areas for regional provision of service”
“permanently forbidden Stand-alone Non-Public Network (SNPNs)”
“temporarily forbidden Stand-alone Non-Public Network (SNPNs)”

When the UE tries to access a cell or PLMN due to a DC, if a cell's TAI is in any of the lists listed above (e.g., in a “5GS forbidden tracking areas for roaming”), or the stand-alone non-public network (SNPN) ID or SNPN, or PLMN of the SNPN is in any of the lists above (e.g. “temporarily forbidden SNPNs”), then the UE may autonomously remove the TAI or the SNPN from the corresponding forbidden list so as to enable the UE to access the cell. The UE may create a new list (e.g., “temporarily allowed 5GS tracking areas for roaming” or “temporarily allowed SNPN for roaming”) and save the corresponding entry (e.g., TAI or SNPN) in this list. This then removes any local restriction in the UE, and the UE can then access the cell or SNPN or the TAI.

When the UE deregisters from the PLMN, or goes back and (optionally successfully) registers on the source PLMN, the UE may reinstate the entry (e.g., TAI or SNPN) into its original list and delete the created temporary list. For example, if the list of “temporarily allowed 5GS tracking areas for roaming” is not empty, the UE saves its entries into the list of “5GS forbidden tracking areas for roaming” and deletes the temporary list. The same can be done with the other types of information (e.g., SNPN and “temporarily allowed SNPN for roaming”).

A further aspect enables a quick UE return to the previous (source) PLMN. The UE may return to the previous PLMN when the UE, based on any method, determines that it has moved out of the area of a DC. This may be based on an explicit indication from the network.

For example, the UE may be handed over to a cell that is outside, which does not align or overlap with, the area of the DC. As such, the serving AMF may send an explicit indication to the UE, indicating that the UE is now out of the area of the DC. This may be performed by the AMF monitoring the UE's location per cell (e.g., based on the global cell identity of the serving cell for a UE in connected mode), such that the AMF should compare the UE's location with the area of the DC. If the AMF determines that the UE is now outside of the DC, the AMF may send an explicit indication to inform the UE about this. This explicit indication may be done using any NAS message (e.g., a configuration update command message including this new indication, a registration accept message including this indication, or a registration reject or service reject message, or a deregistration request message including this new indication).

Upon reception of this indication, the UE may start a timer, T3540, to guard the release of the NAS signaling connection. The UE may release the NAS connection when T3540 expires. The UE may then scan for a higher priority PLMN, that optionally being the previous PLMN that had a DC (e.g., PLMN X). As such, this enables a quick return to the previous PLMN.

Other steps to enable a quick return to a previous PLMN or a higher priority PLMN are described below.

Upon reception of any NAS reject message (e.g., registration reject or service reject message) by a UE that is using a PLMN following a DC, the UE may consider this as a trigger to perform a PLMN search of a higher priority PLMN. The UE may use this a means to determine that the UE has moved outside of the DC area and, as such, should be capable of finding the source PLMN that had experienced a DC (e.g., PLMN X). The UE should attempt to scan and search for the source PLMN on which a DC occurred (e.g., PLMN X). This scan should occur even if other triggers for higher priority PLMN search did not yet occur.

Alternatively, the UE can autonomously start the higher priority PLMN scan when it moves out of the allowed area, or when it moves into a non-allowed area. This can be determined by the UE verifying the TAI of the cell on which it is camping, versus the TAI(s) in the service area list. When the UE determines that it is not in the allowed area (or inside a non-allowed area), the UE may conclude that it has left the area of the DC, and as such should start its scan for a higher priority PLMN and attempt to register on the previous PLMN (on which a DC occurred).

Alternatively, the UE may verify if it is within the DC by monitoring and comparing the global cell ID of a cell onto which it is camped against a list of global cell IDs that the UE may have received from the network as set out herein. The UE may have a list of global cell ID that indicates which cells the UE is allowed to access in this PLMN. If the UE moves to a new cell for which the global cell ID is not part of the stored or received list, the UE may determine that it has come out of the DC area. Based on this, the UE may determine to perform a higher priority PLMN scan and attempt to register on the previous PLMN.

The UE may use a subset or all of the information that it may have received. For example, to determine if the UE is within the area of the DC, the UE may use the service area list only, or both the service area list and the list of global cell IDs, or the list of global cell IDs only.

Alternatively, the UE may autonomously determine if it has moved out of a DC area by monitoring the broadcast information of a cell. If the cell's broadcast information does not indicate that it accepts inbound roaming UEs due to a DC, or no longer or does not broadcast any other indication about access to the PLMN due to a DC, the UE may determine that it has left the DC area and should then perform a PLMN scan to search for higher priority PLMN and attempt to register on the previous or higher priority PLMN.

When the UE returns to the previous PLMN and successfully registers to it, the UE should clear any local indication or flag that the UE may have saved which indicates that a DC has occurred. The UE may restore any previous restrictions regarding the PLMN on which the UE was using during the DC. For example, the UE may restore any TAI in a list of “5GS forbidden tracking areas for roaming” if the UE had removed any TAI from that list when the UE attempted to register on the target PLMN as a result of a DC on a source PLMN.

The DC may also impact non-3GPP access. As such, the UE may determine, via an explicit or implicit method, that the non-3GPP access is unavailable due to a DC.

The explicit method may be via an indication that the UE receives in a NAS message or an RRC message (e.g., via the system information blocks (SIBs) or master information blocks (MIBs) of the broadcast system information of a cell).

The non-3GPP access does not support the concept of TAI and, in fact, for the non-3GPP access, the PLMN indicates one TAI for the entire PLMN. As such, the UE can never know, based on TAI, if it has changed its location while it connects to the non-3GPP access. If the non-3GPP access is unavailable (e.g., due to a DC), the UE's lower layers (i.e., non-3GPP access) may continuously scan for the availability of non-3GPP access. To avoid this, and consequently to avoid excess power consumption in the UE, when the UE determines, based on explicit or implicit indications, that a DC has impacted an access technology, the UE may (e.g., based on the access technology type) disable the access technology to avoid unnecessary power consumption caused by scanning. For example, the UE may disable the non-3GPP access if the UE determines that the non-3GPP access is not available.

The AMF from the serving PLMN may inform the UE whether it should disable an impacted access or not. For example, the AMF may be aware of a DC on an access type (e.g., 3GPP access) and may also be aware that there is no other alternative PLMN in the DC area. As such, the AMF should inform the UE that a DC has occurred and that there is no other PLMN to serve the UE on that access. The UE may then disable the affected access technology.

Regarding the unavailability of non-3GPP access, it is possible that the UE is registered to a PLMN (e.g., PLMN X) over both the 3GPP and non-3GPP accesses. Then a DC may occur that cause the non-3GPP access to be unavailable. The UE cannot know the exact area of the disaster condition if it is not informed about it by the network. Once the UE knows about the DC (e.g., via an explicit indication from the network), the UE may disable the non-3GPP access (e.g., turn it off) in order to not waste power. The UE may then enable the non-3GPP access (e.g., turn it on) when any of the following occurs, in any combination: the UE enters into a new cell on the 3GPP access, even if the cell belongs to a TAI that is part of the UE's registration area; or the UE enters into a new cell whose TAI is not in the UE's list of the UE's registration area.

When any of the above occur, the UE may power on the non-3GPP access and attempt to connect to the 5GC. This is because a 3GPP cell or TA is much larger than the coverage area of non-3GPP access points and the fact that the UE has moved into a new cell or a new TAI would most likely mean that the UE has also moved out of the area of the DC that impacted the non-3GPP access.

Embodiments also provide a means to reduce congestion that may result from numerous 5GSM requests in a PLMN without a DC.

Several UEs may register at about the same time in a PLMN without a DC after the UE's source PLMN experienced a DC.

In addition to handling 5GMM messages, the AMF may experience a large amount of signaling resulting from numerous simultaneous requests for PDU sessions from numerous UEs at around the same time. Each UE may request more than one PDU session, and since the DC happens in one given area, all the UE are expected to be in the same area in the target PLMN and will therefore be served by the same AMF, and possibly SMF if the slices requested and/or DNN are the same.

As all 5GSM messages (e.g., PDU session establishment request messages) are transported within 5GMM messages, the serving AMF will experience a surge of signaling as a consequence of potentially multiple 5GSM requests that are initiated by one UE, let alone numerous UEs.

One solution to prevent an overload, and to control the amount of generated signaling that an AMF will experience, is that the AMF may indicate a restriction on the number of PDU sessions that each UE can request, optionally with a set of timers, where the AMF may indicate a time before which the UE can make its first request following a successful registration and/or indicate a time that the UE needs to wait before a subsequent 5GSM request can be made by a UE following a previous 5GSM request.

The AMF may also remove the restriction at a later time when the load is determined to be under control. All of these indications may be sent by the AMF using any NAS message.

For example, when the UE registers with the network, the AMF may indicate the following to the UE in the registration accept message: a maximum number of PDU sessions or slices that can be requested by the UE; optionally, a time to wait before the first request can be made (e.g., with respect to PDU session or slice); optionally a time to wait in between subsequent 5GSM requests (e.g., with respect to PDU session or slice); optionally an allowed network slice selection assistance information (NSSAI) with a limited number of single-NSSAIs (S-NSSAIs), where the number may be determined based on AMF policy or subscription. This may still be done even if the UE is allowed to use more than one S-NSSAI in this serving PLMN.

The AMF may allow a different number of PDU sessions for each UE, based on local policy or based on subscription information.

When the load condition is determined to be under control, and the AMF determines that more 5GSM requests can be accommodated (e.g., based on local policy or load conditions at the AMF and/or SMF), the AMF may send any NAS message (new or existing) to remove the restriction on the number of PDU sessions that can be requested by the UE.

For example, the AMF may send a configuration update command message to remove the restriction on the number of PDU sessions that are allowed for a UE or modify the number. This may also be done in registration accept message or any other NAS message.

The numbers and timers described above may be defined using new IEs. The bits or fields of these IEs may be defined to provide specific indications, such as an integer number of PDU sessions that may be permitted for a UE, whether or not the restriction is completely removed (i.e., no restrictions are in place).

Note that the restriction on the number of PDU sessions is not necessarily the same as the maximum number of PDU sessions that the PLMN can support per UE. For example, this maximum may be 4 but as the UEs registers with the PLMN, the AMF may initially allow only one PDU session per UE. This restriction can later be lifted such that the UE may be allowed to request more PDU sessions. This solution enables the AMF to avoid congestion instead of having to apply congestion control when congestion is detected, which may also lead to cases in which one UE may get more PDU sessions that another UE which registers at as slightly later time but got backed-off due to the surge in signaling.

The UE may receive, in any NAS message (new or existing), a restriction on the number of PDU sessions that can be requested in a network. In this case, the UE should save a local indication about the restriction and also save the maximum current number of PDU sessions that is permitted by the network, optionally for a given time.

The UE should, upon request to send a new request for establishing a new PDU session, verify if there are any restrictions on 5GSM requests (such as, but not limited to, PDU session establishment request). If yes, the UE verifies if the number of currently established PDU sessions has reached the maximum number that is permitted by the network. If yes, the UE should block the request (i.e., not send the 5GSM request), and indicate to the 5GSM entity (or upper layers) that the request cannot be sent due to a limit or restriction.

The UE may receive a time value that indicates when a first, or subsequent, 5GSM request can be sent by the UE. If so, the UE should start a timer that guards a period during which no 5GSM request can be sent, except for emergency services or high priority access. If the UE is permitted to send a request but a wait period is required (e.g., based on a running timer), then the UE should not send the 5GSM request. The UE may indicate to the 5GSM entity (or upper layers) that the request cannot be sent due to a “back-off” period. The UE may indicate a time period that the 5GSM entity (or upper layers) need to wait for requesting the transmission of the 5GSM message again. This may be done by providing the remaining timer (that the UE had received, if any, and had started) to the 5GSM entity (or upper layers). Upon expiry of the timer, the UE may send a 5GSM request if received from the 5GSM entity (or upper layers), assuming other restrictions are not in place.

If the UE receives a modified restriction (e.g., no more restriction on the number of PDU sessions that can be requested, or the number permitted has now increased), the UE may inform the 5GSM entity (or upper layers) about this so that new requests can be submitted, if any.

To avoid congestion on the PLMN-A (the active PLMN which provides support during disaster situation of the PLMN-D), the PLMN-D (the PLMN experiencing the disaster situation) or HPLMN can indicate to the PLMN-A the PDU sessions (e.g. in the form of data network names (DNNs)) or slice(s) to be prioritized during the congestion situation. Based on this information, the PLMN-A can indicate the PDU session(s) or slice(s) allowed to the UE, based on the congestion situation or anticipated congestion situation of PLMN-A. The UE uses this information as described with respect to time. If the UE makes a request for non-allowed PDU session(s) or slice(s), then the network provides a respective back-off timer.

The UE can be pre-configured with priority of PDU session(s) or slice(s) to be used during the congestion or anticipated congestion situation, for example, in the UE route selection policy (URSP) rules of the UE, or based on any other user interaction or indication from the network.

The indications from the network may come to the UE in a NAS message, but the origins of the indications may be from other network nodes such as the policy and charging control (PCC) node, and as such, the indications may be received in a UE policy container, or a steering of roaming (SOR) transparent container, or UE parameters update transparent container. The indication may be sent in any new IE or existing IE or container (new or existing), or in any new or existing NAS message.

The above-described steps can be used by the network to control or avoid congestion at any time and are not to be restricted to any particular feature such as minimization of service interruption (MINT). As such, the above-described steps can be used at any time. In this case, the UE and the network may negotiate capabilities to indicate that at least the UE can support applying such restrictions from the network. Therefore, the network may provide such restrictions, or modify or remove them for UEs that indicate support of such restrictions. The network may apply the above steps for UEs that indicate the support of the MINT feature or for UEs that are known to register on a network following a disaster condition in a source PLMN.

At least some of the example embodiments described herein may be constructed, partially or wholly, using dedicated special-purpose hardware. Terms such as “component”, “module” or “unit” used herein may include, but are not limited to, a hardware device, such as circuitry in the form of discrete or integrated components, a field programmable gate array (FPGA) or an application specific integrated circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents, which are filed concurrently with or previous to this specification in connection with this application, and which are open to public inspection with this specification, and the contents of all such papers and documents are incorporated herein by reference.

All of the features disclosed herein (including any accompanying claims, abstract and drawings), and/or all of the steps of any method or process so disclosed, may be combined in any combination, except combinations where at least some of such features and/or steps are mutually exclusive.

Each feature disclosed herein (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

While the disclosure has been shown and described with reference to certain embodiments thereof, it will be understood by those skilled in the art that various changes in form and detail may be made therein without departing from the scope of the disclosure. Therefore, the scope of the disclosure should not be defined as being limited to the embodiments, but should be defined by the appended claims and equivalents thereof.

What is claimed is:

1. A method of controlling access to a network supporting disaster roaming, the method comprising:
receiving, at the network, non-access stratum (NAS) message from a user equipment (UE);
verifying, by the network, at least one condition in response to the NAS message; and
based on the at least one condition, accepting, by the network, the NAS message and indicating, by the network, that the UE is registered for emergency services.

2. The method of claim 1, wherein the at least one condition comprises the UE moving outside a previous registration area (RA) of the UE, the UE moving into a new tracking area (TA), or the UE sending the NAS message from a cell or a TA that is outside a current RA of the UE.

3. The method of claim 1, wherein the at least one condition comprises that the UE is registered for a disaster roaming service.

4. The method of claim 1, wherein the at least one condition is that the UE has a protocol data unit (PDU) session for emergency services.

5. The method of claim 1, wherein the at least one condition is verified in any order or combination.

6. The method of claim 1, wherein the at least one condition comprises a plurality of conditions and upon all of the plurality of conditions being met, the network considers the UE to be registered for emergency services.

7. The method of claim 6, further comprising:
indicating, by the network, to the UE, in a second NAS message, that the UE is registered for emergency services.

8. The method of claim 7, wherein the second NAS message is a registration accept message or a configuration update command message.

9. The method of claim 7, wherein in case that the at least one condition is not met, the network rejects the NAS message from the UE.

10. The method of claim 9, wherein the second NAS message is a registration reject message.

11. An apparatus comprising:
at least one processor; and
a memory operably connected to the at least one processor and storing instructions configured to cause, when executed, the at least one processor to:
receive a non-access stratum (NAS) message from a user equipment (UE);
verify at least one condition in response to the NAS message; and
based on the at least one condition, accept the NAS message and indicate that the UE is registered for emergency services.

12. A method performed by a user equipment (UE) to access to a network supporting disaster roaming, the method comprising:
transmitting, to the network, a non-access stratum (NAS) message; and
obtaining, from the network, an indication that the UE is registered for emergency services, based on a verification of at least one condition in response to the NAS message.

13. The method of claim 12, wherein the at least one condition comprises the UE moving outside a previous registration area (RA) of the UE, the UE moving into a new tracking area (TA), or the UE sending the NAS message from a cell or a TA that is outside a current RA of the UE.

14. The method of claim 12, wherein in case that the at least one condition is not met, the NAS message is rejected.

15. An user equipment (UE) comprising:
at least one processor; and
a memory operably connected to the at least one processor and storing instructions configured to cause, when executed, the at least one processor to:
transmit, to the network, a non-access stratum (NAS) message; and
obtain, from the network, an indication that the UE is registered for emergency services, based on a verification of at least one condition in response to the NAS message.
